(19) United States
(12) Patent Application Publication
(10) Pub. No.: US 2026/0356189 A1
(43) Pub. Date: Nov. 12, 2026

(54) DUMP TRUCK

(71) Applicant: KOMATSU LTD., Tokyo (JP)

(72) Inventors: Yuta Hoshino, Tokyo (JP); Yuuki Ishikawa, Tokyo (JP); Ryousuke Maeda, Tokyo (JP); Masafumi Kuroda, Tokyo (JP); Shuhei Kousaka, Tokyo (JP)

(73) Assignee: KOMATSU LTD., Tokyo (JP)

(21) Appl. No.: 19/123,335

(22) PCT Filed: Sep. 26, 2023
(86) PCT No.: PCT/JP2023/034947

§ 371 Date: Apr. 22, 2025

(30) Foreign Application Priority Data
Nov. 14, 2022 (JP) 2022-181817

(51) Int. Cl. B60K 15/01; B60K 15/03; B60K 15/063; B60P 1/28

(52) U.S. Cl. CPC B60K 15/01; B60K 15/063; B60P 1/283; B60K 2015/03256; B60K 2015/03315

(57) ABSTRACT

This dump truck is a dump truck including a vehicle body frame on which a drive source using hydrogen as fuel is mounted, and a dump body that is pivotably joined to the vehicle body frame at a pivot portion, a load is to be mounted on the dump body. The dump truck further includes a hydrogen tank configured to store the hydrogen. The hydrogen tank is provided for the dump body.

### TECHNICAL FIELD

The present invention relates to a dump truck.

The present invention claims the priority based on Japanese Patent Application No. 2022-181817 filed on Nov. 14, 2022 in Japan, the content of which is incorporated herein by reference.

### BACKGROUND ART

For carbon neutrality, it is urgent to achieve zero emission from mining machines, construction machines, and the like. One technology for achieving zero emission is a fuel cell system. For example, the fuel cell system includes a fuel cell (FC), a battery, and a hydrogen tank that stores hydrogen as fuel. Hydrogen as the fuel has a lower volumetric energy density than those of other types of fuel such as light oil. For example, even if high-pressure hydrogen (about 70 MPa) is stored in the volume of a current light oil tank, the energy thereof is 1/10 or less of that of light oil. That is, when hydrogen is used as the fuel, an operation time is shorter than that when light oil is used as the fuel.

For example, Patent Literature 1 discloses a fuel cell vehicle including a fuel cell stack, and a first hydrogen tank and a second hydrogen tank that supply hydrogen to the fuel cell stack. The first hydrogen tank is disposed below a tunnel portion of a front floor panel. The second hydrogen tank is disposed below a rear floor panel. The first hydrogen tank and the second hydrogen tank are provided at a vehicle body lower portion (vehicle lower side).

### CITATION LIST

### Patent Literature

PTL 1: JP2019-189028A

### SUMMARY OF INVENTION

### Technical Problem

However, a space below the vehicle body is limited, and it is difficult to mount a great number of first hydrogen tanks and second hydrogen tanks. For this reason, there is still room for improvement in mounting a great number of hydrogen tanks that store hydrogen having a lower volumetric energy density in a limited space of a vehicle.

Therefore, an object of the present invention is to provide a dump truck capable of mounting a great amount of hydrogen as a fuel.

### Solution to Problem

A dump truck according to one aspect of the present invention is a dump truck including a vehicle body frame on which a drive source using hydrogen as fuel is mounted, and a dump body that is pivotably joined to the vehicle body frame at a pivot portion, a load is to be mounted on the dump body. The dump truck further includes a hydrogen tank configured to store the hydrogen. The hydrogen tank is provided for the dump body.

### Advantageous Effects of Invention

According to the above-described aspect, a great amount of hydrogen as the fuel can be mounted.

### BRIEF DESCRIPTION OF DRAWINGS

FIG. 1 is a side view of a dump truck according to an embodiment.

FIG. 2 is a side view of the dump truck according to the embodiment when a load is discharged.

FIG. 3 is a front view of f the dump truck according to the embodiment.

FIG. 4 is a block diagram of a hydrogen supply system according to the embodiment.

### DESCRIPTION OF EMBODIMENTS

An embodiment of the present invention will be described below with reference to the drawings. The embodiment will be described with reference to a case where a dump truck, which is a transportation vehicle that travels at a work site such as a mine and transports a load, is presented as a work vehicle forming a hydrogen supply system.

### Dump Truck

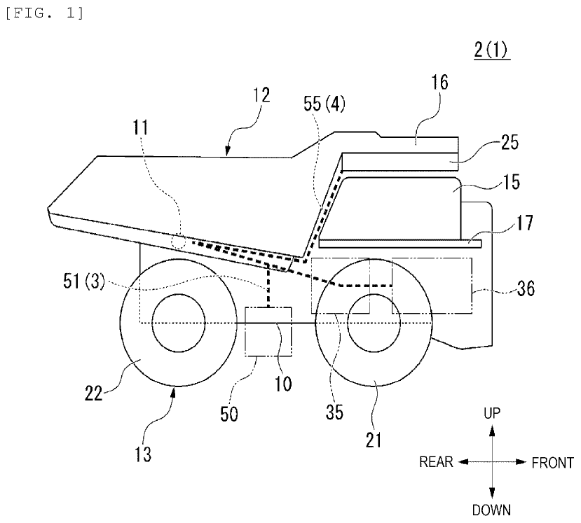

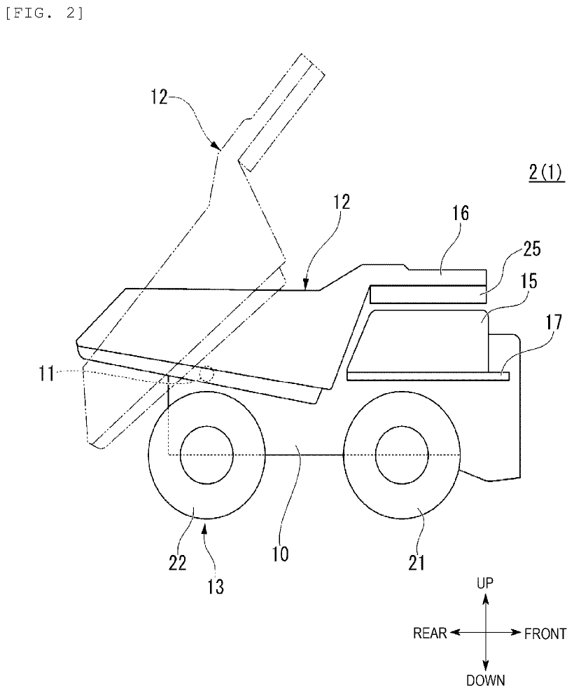

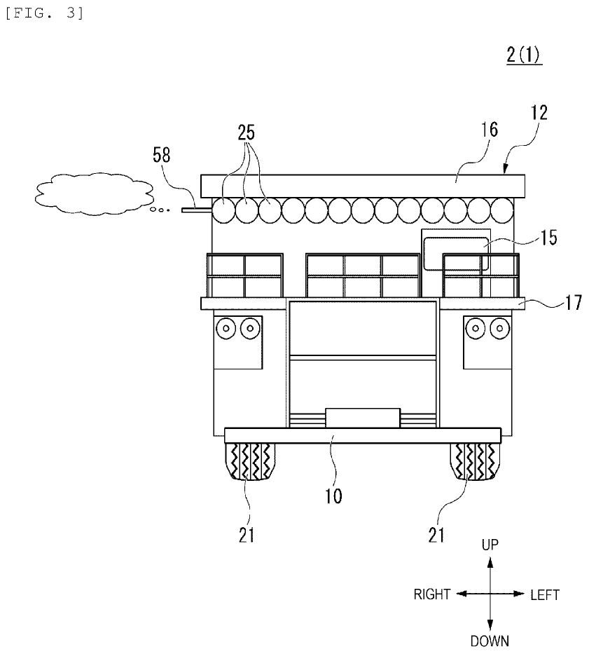

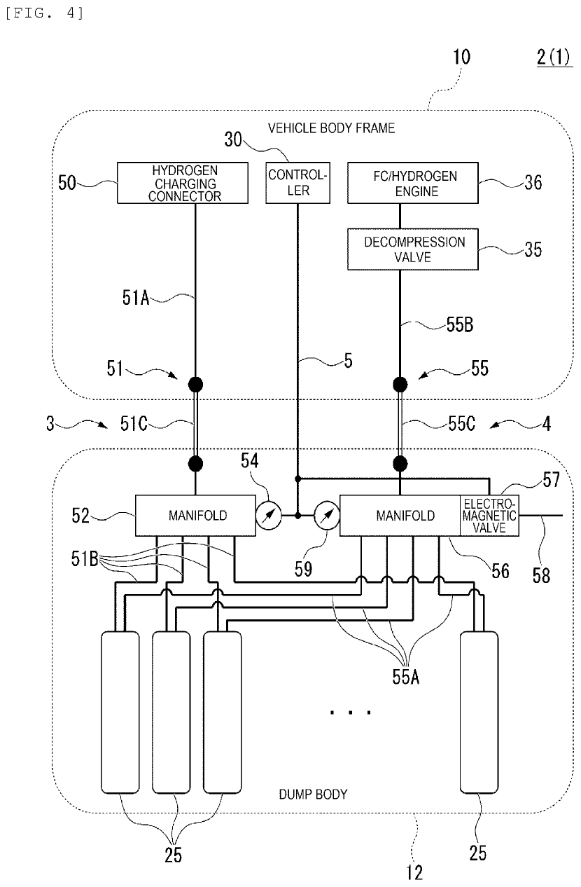

FIG. 1 is a side view of a dump truck 2 according to the embodiment. FIG. 2 is a side view of the dump truck 2 according to the embodiment when the load is discharged. FIG. 3 is a front view of the dump truck 2 according to the embodiment. FIG. 4 is a block diagram of a hydrogen supply system 1 according to the embodiment.

Referring to FIGS. 1 to 4, the dump truck 2 further includes a vehicle body frame 10 equipped with a drive source 36 using hydrogen as fuel, a dump body 12 (equivalent to a vessel) which is pivotably joined to the vehicle body frame 10 at a pivot portion 11 and on which the load is to be mounted, and a traveling device 13 supporting the vehicle body frame 10. For example, the dump truck 2 may be an unmanned dump truck to be driven in an unmanned manner without depending on a driving operation by a driver, or may be a manned dump truck to be driven based on a driving operation by a driver.

Hereinafter, the Forward Direction (vehicle Body front), backward direction (vehicle body rear), and vehicle width direction (vehicle body left-right direction) of the dump truck 2 will be referred to as a “vehicle front (one side in the vehicle front-rear direction)”, a “vehicle rear (other side in the vehicle front-rear direction)”, and a “vehicle width direction”. The vehicle width direction may also be referred to as a “left side (one side in the vehicle width direction)” or a “right side (other side in the vehicle width direction)”. The right-hand side in the direction in which the dump truck 2 moves forward will be referred to as the right side, and the left-hand side in the direction in which the dump truck 2 moves forward will be referred to as the left side. The vehicle up-down direction (vehicle body up-down direction), the vehicle upper side (vehicle body upper side), and vehicle lower side (vehicle body lower side) of the dump truck 2 will be simply referred to as an “up-down direction”, an “upper side/above”, and a “lower side/below”, respectively. In the example shown in the drawings, the dump truck 2 is disposed on a horizontal plane (horizontal ground). The vehicle up-down direction (vehicle body up-down direction), vehicle upper side (vehicle body upper side), and vehicle lower side (vehicle body lower side) of the dump truck 2 coincide with an up-down direction (vertical direction), a vertically upper side, and a vertically lower side in a state in which the dump truck 2 is disposed on the horizontal plane, respectively.

The vehicle body frame 10 extends in the vehicle front-rear direction. The vehicle body frame 10 pivotably supports the dump body 12 via the pivot portion 11. The pivot portion 11 is a portion including a shaft portion (equivalent to the pivot center axis of the dump body 12) extending in the vehicle width direction on the vehicle body frame 10. The vehicle body frame 10 is supported by the traveling device 13.

The dump body 12 is pivotably joined to the vehicle body frame 10 at the pivot portion 11. The dump body 12 is a member (equivalent to a cargo bed) on which the load is loaded. At least part of the dump body 12 is disposed higher than the vehicle body frame 10. The dump body 12 can perform a dumping operation and a lowering operation.

The dumping operation means an operation of separating the dump body 12 from the vehicle body frame 10 and inclining the dump body 12 in a dumping direction. The dumping direction is rearward of the vehicle body frame 10. In the embodiment, the dumping operation includes lifting a front end portion of the dump body 12 and inclining the dump body 12 rearward. By the dumping operation, the loading surface of the dump body 12 is inclined downward toward the rear side.

The lowering operation means an operation of bringing the dump body 12 close to the vehicle body frame 10. The lowering operation is an operation in the direction opposite to that of the dumping operation. In the embodiment, the lowering operation includes lowering the front end portion of the dump body 12.

The dump body 12 is adjusted to a dump posture and a loading posture by the dumping operation and the lowering operation. The dump posture means a posture in which the dump body 12 is lifted. The loading posture means a posture in which the dump body 12 is lowered. In the example of FIG. 2, the dump body 12 in the loading posture is indicated by a solid line, and the dump body 12 in the dump posture is indicated by a two-dot chain line.

For example, when performing a discharge work, the dump body 12 performs the dumping operation so as to change from the loading posture to the dump posture. In a case where the load is loaded on the dump body 12, the load is discharged rearward from a rear end portion of the dump body 12 by the dumping operation. When performing a loading work, the dump body 12 is adjusted to the loading posture.

The dump body 12 includes a protector 16 that protects a cab 15 from above. The protector 16 is disposed so as to cover the cab 15 from above when the dump body 12 is in the loading posture. The protector 16 is provided on the front end side of the dump body 12. The protector 16 is disposed higher than the cab 15. The protector 16 extends in the vehicle width direction. For example, the cab 15 is disposed on the vehicle left side with respect to the center in the vehicle width direction.

The cab 15 is supported by a platform 17. The platform 17 is provided to secure a scaffold when an operator gets on and off the cab 15. The platform 17 is provided to secure a scaffold upon maintenance of equipment mounted on the dump truck 2. The platform 17 is disposed lower than the protector 16. The platform 17 is disposed higher than wheels 21, 22. The platform 17 extends in the vehicle width direction. The platform 17 is formed in a plate shape parallel to the vehicle front-rear direction and the vehicle width direction.

The traveling device 13 supports the vehicle body frame 10. The traveling device 13 causes the dump truck 2 to travel. The traveling device 13 moves the dump truck 2 forward or backward. At least part of the traveling device 13 is disposed lower than the vehicle body frame 10. The traveling device 13 includes the plurality of wheels 21, 22. The plurality of wheels 21, 22 includes front wheels 21 and rear wheels 22 disposed in rear of the front wheels 21.

The front wheels 21 are wheels to be steered to change the movement direction of the dump truck 2. The left and right front wheels 21 are disposed in pair. The pair of left and right front wheels 21 is disposed with a gap in the vehicle width direction through a front portion of the vehicle body frame 10. One front wheel 21 is provided on each of the left and right sides (two in total).

The rear wheels 22 are drive wheels to be driven by the drive source 36. The left and right rear wheels 22 are disposed in pair. The pair of left and right rear wheels 22 is disposed with a gap in the vehicle width direction through a rear portion of the vehicle body frame 10. Two rear wheels 22 are provided on each of the left and right sides (four in total).

### Hydrogen Tank

The dump truck 2 further includes a hydrogen tank 25 storing hydrogen as the fuel. The hydrogen tank 25 is provided for the dump body 12. In the present embodiment, the hydrogen tank 25 is provided below the protector 16. The hydrogen tank 25 has a cylindrical shape. The plurality of hydrogen tanks 25 is provided in the vehicle width direction along the lower surface of the protector 16. In the example of FIG. 3 thirteen hydrogen tanks 25 (an example of the plurality of hydrogen tanks 25) are arranged side by side in the vehicle width direction.

Note that the shape, number, and arrangement of the hydrogen tanks 25 are not limited to those described above. For example, the hydrogen tank 25 may have a flat shape. For example, the number of hydrogen tanks 25 may be 12 or less or 14 or more. For example, the hydrogen tanks 25 may be vertically stacked on each other. For example, the hydrogen tanks 25 may be stacked in two or more stages on the lower surface of the protector 16. For example, the shape, number, and arrangement of the hydrogen tanks 25 can be changed according to design specifications.

For example, the hydrogen tank 25 is detachably coupled to the lower surface of the protector 16 with a coupling member (not shown) such as a U-shaped band or a U-shaped bolt. For example, a plurality of coupling members is provided at positions corresponding to respective ones of the plurality of hydrogen tanks 25. For example, the coupling members are configured to couple the hydrogen tanks 25 one by one to the lower surface of the protector 16.

Note that the configuration of the coupling member is not limited to the configuration described above. For example, only one coupling member may be provided corresponding to the plurality of hydrogen tanks 25. For example, the coupling member may be configured to collectively couple the plurality of hydrogen tanks 25 to the lower surface of the protector 16. For example, the configuration of the coupling member can be changed according to design specifications.

### Hydrogen Supply System

The elements of the hydrogen supply system 1 (an example of a system) are mounted on the vehicle body frame 10 and the dump body 12.

The vehicle body frame 10 is equipped with a controller 30, a decompression valve 35, the drive source 36 (equivalent to an FC/hydrogen engine), and a hydrogen charging connector 50.

The dump body 12 is equipped with the hydrogen tank 25, a hydrogen charging manifold 52, a hydrogen charging pressure sensor 54, a hydrogen supply manifold 56, an electromagnetic valve 57, a hydrogen discharge pipe 58, and a hydrogen supply pressure sensor 59.

A harness 5 is capable of transmitting a control signal from the controller 30 mounted on the vehicle body frame 10 to the dump body 12. For example, the harness 5 includes a plurality of electric wires (for example, electric wire bundle).

One end (end portion opposite to the end portion joined to the dump body 12 side) of the harness 5 is connected to the controller 30. For example, the controller 30 has a processing unit which is a processor such as a CPU, a storage unit such as a RAM, a ROM, or a combination thereof, and an input/output unit. The processing unit controls operations of the elements of the system. The storage unit stores a computer program for implementing the function of the processing unit and information necessary for the processing of the processing unit. The input/output unit is an interface circuit between the controller 30 and other devices.

The hydrogen supply system 1 includes a hydrogen charging line 3 for charging the hydrogen tank 25 with hydrogen as the fuel, and a hydrogen supply line 4 for supplying hydrogen in the hydrogen tank 25 to the drive source 36. In the present embodiment, the hydrogen charging line 3 and the hydrogen supply line 4 are configured to have hydrogen flow paths different from each other.

### Hydrogen Charging Line

The hydrogen charging line 3 includes a hydrogen charging pipe 51 and the hydrogen charging manifold 52. The hydrogen charging pipe 51 includes a first charging portion 51A provided for the vehicle body frame 10, a second charging portion 51B provided on the lower surface of the dump body 12, and a bendable third charging portion 51C joining the first charging portion 51A and the second charging portion 51B in the vicinity of the pivot portion 11.

For example, the first charging portion 51A and the second charging portion 51B are formed of metal pipes. For example, the first charging portion 51A and the second charging portion 51B are formed of high-pressure metal pipes which can withstand high-pressure hydrogen (about 70 MPa, for example). For example, the third charging portion 51C is formed of a hose. For example, the third charging portion 51C is formed of a hose which can withstand swinging and high-pressure hydrogen (about 70 MPa, for example).

The plurality of second charging portions 51B is provided for the dump body 12. For example, the hydrogen charging manifold 52 is provided at a left side portion (one side portion in the vehicle width direction) of the dump body 12. The hydrogen charging manifold 52 has a structure in which one pipe (equivalent to the third charging portion 51C) is branched into a plurality of pipes (equivalent to the plurality of second charging portions 51B corresponding to the plurality of hydrogen tanks 25).

The hydrogen charging connector 50 is connected to the hydrogen charging manifold 52 through the first charging portion 51A and the third charging portion 51C forming the hydrogen charging pipe 51. The hydrogen charging manifold 52 is connected to the hydrogen tank 25 through the second charging portion 51B forming the hydrogen charging pipe 51. The hydrogen tank 25 is filled with hydrogen through the hydrogen charging connector 50, the first charging portion 51A (equivalent to the metal pipe), the third charging portion 51C (equivalent to the hose), the hydrogen charging manifold 52, and the second charging portion 51B (equivalent to the metal pipe).

The hydrogen charging pressure sensor 54 is connected to the hydrogen charging manifold 52. The hydrogen charging pressure sensor 54 measures the pressure in the hydrogen charging manifold 52.

### Hydrogen Supply Line

The hydrogen supply line 4 includes a hydrogen supply pipe 55 and the hydrogen supply manifold 56. The hydrogen supply pipe 55 includes a first supply portion 55A provided on the lower surface of the dump body 12, a second supply portion 55B provided for the vehicle body frame 10, and a bendable third supply portion 55C joining the first supply portion 55A and the second supply portion 55B in the vicinity of the pivot portion 11.

For example, the first supply portion 55A and the second supply portion 55B are formed of metal pipes. For example, the first supply portion 55A and the second supply portion 55B are formed of high-pressure metal pipes which can withstand high-pressure hydrogen (about 70 MPa, for example). For example, the third supply portion 55C is formed of a hose. For example, the third supply portion 55C is formed of a hose which can withstand swinging and high-pressure hydrogen (about 70 MPa, for example).

The plurality of first supply portions 55A is provided for the dump body 12. For example, the hydrogen supply manifold 56 is provided at a right side portion (other side portion in the vehicle width direction) of the dump body 12. The hydrogen supply manifold 56 has a structure in which a plurality of pipes (equivalent to the plurality of first supply portions 55A corresponding to the plurality of hydrogen tanks 25) is joined into one pipe (equivalent to the third supply portion 55C).

The hydrogen tank 25 is connected to the hydrogen supply manifold 56 through the first supply portion 55A forming the hydrogen supply pipe 55. The hydrogen supply manifold 56 is connected to the drive source 36 through the second supply portion 55B, the third supply portion 55C, and the like forming the hydrogen supply pipe 55. Hydrogen is supplied to the drive source 36 through the hydrogen tank 25, the first supply portion 55A (equivalent to the metal pipe), the hydrogen supply manifold 56, the third supply portion 55C (equivalent to the hose), the second supply portion 55B (equivalent to the metal pipe), and the like.

The hydrogen discharge pipe 58 branches off from the hydrogen supply manifold 56. The hydrogen discharge pipe 58 discharges hydrogen gas obtained by vaporizing hydrogen as the fuel. The hydrogen discharge pipe 58 discharges the hydrogen gas through the side surface of the dump body 12. The hydrogen discharge pipe 58 is connected to the hydrogen supply manifold 56 through the electromagnetic valve 57. For example, in an emergency, the hydrogen gas in the hydrogen supply manifold 56 may be discharged to the outside through the hydrogen discharge pipe 58.

The hydrogen supply pressure sensor 59 is connected to the hydrogen supply manifold 56. The hydrogen supply pressure sensor 59 measures the pressure in the hydrogen supply manifold 56.

The other end (end portion branching off from a portion opposite the end portion joined to the controller 30) of the harness 5 is electrically connected to the hydrogen charging pressure sensor 54, the hydrogen supply pressure sensor 59, and the electromagnetic valve 57. The detection results (pressure detection signals) of the hydrogen charging pressure sensor 54 and the hydrogen supply pressure sensor 59 are input to the controller 30 via the harness 5.

One end (end portion opposite to the end portion joined to the third supply portion 55C) of the second supply portion 55B is connected to the decompression valve 35 for decompressing the fuel. The decompression valve 35 is provided between the second supply portion 55B and the drive source 36. The decompression valve 35 is connected to the drive source 36. The decompression valve 35 has a function of releasing a high pressure in the second supply portion 55B (primary side) to maintain the pressure on the drive source 36 side (secondary side) at a predetermined pressure.

The drive source 36 includes a fuel cell (FC) that generates power by causing a chemical reaction between hydrogen as fuel gas and oxygen as oxidizing gas, and a hydrogen engine which is an internal combustion engine using hydrogen as fuel. For example, the fuel cell has a stack structure in which a plurality of unit cells is stacked on each other. For example, the fuel cell generates power using oxygen contained in outside air. Note that an oxidizing gas supply device (not shown) may supply the fuel cell with air containing oxygen.

For example, the hydrogen engine generates power to be used to perform the dumping operation or lowering operation of the dump body 12. For example, the hydrogen engine generates power to be used to steer the front wheels 21. For example, the power (rotational force) generated by the hydrogen engine is transmitted to the rear wheels 22 of the traveling device 13.

Note that the hydrogen supply system 1 may include a battery (for example, secondary battery such as lithium ion battery). For example, the battery stores the power generated by the fuel cell. For example, the battery may function as a power source for the dump truck 2, as in the fuel cell.

### Arrangement of Elements of System

Referring also to FIG. 1, the drive source 36 is disposed in vehicle body front of the decompression valve 35. The drive source 36 is disposed lower than the platform 17.

The drive source 36 and the decompression valve 35 are mounted on the vehicle body frame 10. The drive source 36 and the decompression valve 35 are preferably disposed within the area of the vehicle body frame 10 in the vehicle width direction. According to this configuration, the drive source 36 and the decompression valve 35 are covered with the vehicle body frame 10 from the vehicle body lower side. A probability of disturbance (for example, a flying stone or the like) reaching the drive source 36 and the decompression valve 35 from the vehicle body lower side can thus be reduced.

For example, it is necessary to mount a great amount of hydrogen in order to extend an operation time, but there is a limit to an existing location (for example, a space on the vehicle body side). In the present embodiment, the hydrogen tank 25 is disposed on the back surface of the dump body 12 (specifically, the lower surface of the protector 16). Since there is a space which has not been used (unused space) on the back surface of the dump body 12, the unused space can be effectively used. This makes it possible to mount a great number of hydrogen tanks 25.

In particular, since the hydrogen tank 25 is lighter than the battery, even in a case where a great number of hydrogen tanks 25 are mounted on the back surface of the dump body 12, there is a low probability of influencing soil discharging performance or the like. In addition, since hydrogen is lighter than air, even if there is leakage of hydrogen from the hydrogen tank 25, it is preferable from the viewpoint of safety to install the hydrogen tank 25 in the vicinity of the highest location in the dump truck 2 (specifically, the lower surface of the protector 16). For example, the shape of the dump body 12 may be devised (for example, the vertical position of the protector 16 may be raised) so that the hydrogen tanks 25 have a multi-stage configuration (for example, two upper and lower stages). Accordingly, it is possible to further increase the number of hydrogen tanks 25 mounted.

For example, in a case where a pipe (equivalent to a metal pipe) is disposed along the back surface of the dump body 12, the pipe may be disposed so as to pass through the center in the vehicle width direction and then extend to the vehicle body frame 10 side in the vicinity of the pivot portion 11. Thereafter, the portion of the pipe extending to the vehicle body frame 10 side may be connected to the hydrogen charging connector 50 and the drive source 36. For example, the hydrogen charging connector 50 may be installed at a height which allows easy access from the ground. For example, a portion of the pipe extending to immediately before the drive source 36 may be a high-pressure metal pipe which can withstand high-pressure hydrogen (about 70 MPa, for example) in consideration of a pressure loss. A portion of the pipe in the vicinity of the pivot portion 11 may be formed of a hose which can withstand swinging.

For example, when an abnormality such as a fire occurs on the vehicle body frame 10 side, it may be necessary to urgently discharge hydrogen from the hydrogen tank 25. In this case, the hydrogen discharge pipe 58 may be extended to an end portion of the dump body 12 in the form of branching off from the hydrogen supply manifold 56. In the example of FIG. 3, the hydrogen discharge pipe 58 extends rightward of the dump body 12 with respect to the protector 16. Accordingly, the hydrogen gas can be discharged from the right side surface of the dump body 12 through the hydrogen discharge pipe 58.

Note that it is desirable to release hydrogen at a position as high as possible. Therefore, in a case where the hydrogen supply manifold 56 is mounted on the dump body 12, only the hydrogen discharge pipe 58 is extended to the end portion of the dump body 12, and therefore, such a process is easy and excellent safety is exhibited.

### Features and Effects

As described above, the dump truck 2 of the present embodiment includes the vehicle body frame 10 on which the drive source 36 using hydrogen as the fuel is mounted, and the dump body 12 which is pivotably joined to the vehicle body frame 10 at the pivot portion 11 and on which the load is to be mounted. The dump truck 2 further includes the hydrogen tank 25 storing hydrogen. The hydrogen tank 25 is provided for the dump body 12.

According to this configuration, since the hydrogen tank 25 is provided for the dump body 12, it is not necessary to mount a great amount of hydrogen as the fuel in a limited space of the dump truck 2. Therefore, a great amount of hydrogen as the fuel can be mounted.

In the present embodiment, the dump body 12 includes the protector 16 that protects the cab 15 from above. The hydrogen tank 25 is provided below the protector 16.

According to this configuration, as compared with a case where the hydrogen tank 25 is provided above the protector 16, it is possible to reduce a probability of disturbance reaching the hydrogen tank 25 from above the protector 16. For example, it is possible to reduce a probability of the load colliding with the hydrogen tank 25 during loading of the load.

In the present embodiment, the dump truck 2 further includes the hydrogen supply pipe 55 for supplying hydrogen from the hydrogen tank 25 to the drive source 36. The hydrogen supply pipe 55 includes the first supply portion 55A provided on the lower surface of the dump body 12, a second supply portion 55B provided for the vehicle body frame 10, and a bendable third supply portion 55C joining the first supply portion 55A and the second supply portion 55B in the vicinity of the pivot portion 11.

According to this configuration, with a simple configuration including three portions (first supply portion 55A, second supply portion 55B, and third supply portion 55C) in the hydrogen supply pipe 55, the hydrogen supply pipe 55 can be shortened as much as possible without influencing the dumping operation and the lowering operation.

In the present embodiment, the dump truck 2 further includes the decompression valve 35 provided between the second supply portion 55B and the drive source 36 to decompress the fuel. The first supply portion 55A and the second supply portion 55B are formed of the metal pipes. The third supply portion 55C is formed of the hose.

According to this configuration, even in a case where high-pressure hydrogen (about 70 MPa, for example) is stored in the hydrogen tank 25, the hydrogen supply pipe 55 can be shortened as much as possible without influencing the dumping operation and the lowering operation. In addition, as compared with a case where the decompression valve 35 is provided at the first supply portion 55A, the decompression valve 35 can be disposed immediately before the drive source 36 so as to reduce the pressure loss.

In the present embodiment, the plurality of first supply portions 55A is provided for the dump body 12. The dump truck 2 further includes the hydrogen supply manifold 56 provided for the dump body 12 and joining the plurality of first supply portions 55A into the third supply portion 55C.

According to this configuration, as compared with a case where the hydrogen supply manifold 56 is provided for the vehicle body frame 10, it is possible to reduce a probability of the pipe connected to the hydrogen supply manifold 56 being complicated. For example, even in a case where the hydrogen charging path (equivalent to the hydrogen charging line 3) and the hydrogen supply path (equivalent to the hydrogen supply line 4) are different from each other, it is sufficient to provide only one third supply portion 55C for the hydrogen supply line 4. Therefore, the number of installed pipes or the like can be minimized.

In the present embodiment, the dump truck 2 further includes the hydrogen discharge pipe 58 branching off from the hydrogen supply manifold 56 and discharging the hydrogen gas obtained by vaporizing the fuel. The hydrogen discharge pipe 58 discharges the hydrogen gas through the side surface of the dump body 12.

According to this configuration, as compared with a case where the hydrogen supply manifold 56 is provided for the vehicle body frame 10, it is easy to shorten the hydrogen discharge pipe 58 in a case where the hydrogen discharge pipe 58 is extended from the hydrogen supply manifold 56 to the side surface of the dump body 12. In addition, in a case where it is desired to discharge hydrogen from the hydrogen tank 25 for safety, the hydrogen gas can be discharged from the side surface of the dump body 12 through the hydrogen discharge pipe 58, which is excellent in safety.

### Modifications

The embodiment has been described above with reference to the example where the hydrogen tank is provided below the protector, but the present invention is not limited thereto. For example, the hydrogen tank may be provided above the protector. For example, the hydrogen tank may be provided at a portion of the dump body other than the protector. For example, the form in which the hydrogen tank is installed in the dump body can be changed according to design specifications.

The embodiment has been described above with reference to the example where the hydrogen supply pipe includes the first supply portion provided on the lower surface of the dump body, the second supply portion provided for the vehicle body frame, and the bendable third supply portion joining the first supply portion and the second supply portion in the vicinity of the pivot portion, but the present invention is not limited thereto. For example, the hydrogen supply pipe does not necessarily include the first supply portion, the second supply portion, and the third supply portion. For example, the hydrogen supply pipe may extend from the hydrogen tank toward the drive source so as to stretch and contract. For example, the configuration of the hydrogen supply pipe can be changed according to design specifications.

The embodiment has been described above with reference to the example where the decompression valve is provided between the second supply portion and the drive source, but the present invention is not limited thereto. For example, the decompression valve may be provided at a location other than the location between the second supply portion and the drive source. For example, the decompression valve may be provided at the first supply portion. For example, the form in which the decompression valve is installed can be changed according to design specifications.

The embodiment has been described above with reference to the example where the first supply portion and the second supply portion are formed of the metal pipes, but the present invention is not limited thereto. For example, the first supply portion and the second supply portion may be formed of pipes other than the metal pipes. For example, the first supply portion and the second supply portion may be formed of high-pressure pipes which can withstand high-pressure hydrogen (about 70 MPa, for example). For example, the configuration of the first supply portion and the second supply portion can be changed according to design specifications.

The embodiment has been described above with reference to the example where the dump truck further includes the hydrogen supply manifold provided for the dump body and joining the plurality of first supply portions into the third supply portion, but the present invention is not limited thereto. For example, the hydrogen supply manifold may be provided for the vehicle body frame. For example, the form in which the hydrogen supply manifold is installed can be changed according to design specifications.

The embodiment has been described above with reference to the example where the hydrogen discharge pipe branches off from the hydrogen supply manifold provided for the dump body and extends to the side surface of the dump body, but the present invention is not limited thereto. For example, in a case where the hydrogen supply manifold is provided for the vehicle body frame, the hydrogen discharge pipe may branch off from the hydrogen supply manifold provided for the vehicle body frame and extend to the side surface of the dump body. For example, the form in which the hydrogen discharge pipe is installed can be changed according to design specifications.

The embodiment has been described above with reference to the example where the hydrogen charging line and the hydrogen supply line are configured to have the hydrogen flow paths different from each other, but the present invention is not limited thereto. For example, at least part of the hydrogen charging line and the hydrogen supply line may be configured to have the same hydrogen flow path. For example, the forms of the hydrogen charging line and the hydrogen supply line can be changed according to design specifications.

While the embodiments of the present invention have been described above, the present invention is not limited thereto, and additions, omissions, substitutions, and other changes of the configurations can be made without departing from the spirit of the present invention, and the above-described embodiments can be combined as appropriate.

### Appendix 1

A dump truck including a vehicle body frame on which a drive source using hydrogen as fuel is mounted, and a dump body that is pivotably joined to the vehicle body frame at a pivot portion, a load is to be mounted on the dump body, the dump truck further including
a hydrogen tank configured to store the hydrogen,
the hydrogen tank being provided for the dump body.

### Appendix 2

The dump truck according to Appendix 1, in which the dump body includes a protector configured to protect a cab from above, and
the hydrogen tank is provided below the protector.

### Appendix 3

The dump truck according to Appendix 1 or 2, which further includes a hydrogen supply pipe configured to supply the hydrogen from the hydrogen tank to the drive source,
the hydrogen supply pipe including
a first supply portion provided on a lower surface of the dump body,
a second supply portion provided for the vehicle body frame, and
a bendable third supply portion joining the first supply portion and the second supply portion in the vicinity of the pivot portion.

### Appendix 4

The dump truck according to Appendix 3, which further includes a decompression valve provided between the second supply portion and the drive source to decompress the fuel,
the first supply portion and the second supply portion being formed of metal pipes, and
the third supply portion being formed of a hose.

### Appendix 5

The dump truck according to Appendix 3 or 4, in which the first supply portion includes a plurality of first supply portions provided for the dump body, the dump truck further including a hydrogen supply manifold provided for the dump body and joining the plurality of first supply portions into the third supply portion.

### Appendix 6

The dump truck according to Appendix 5, which further includes a hydrogen discharge pipe branching off from the hydrogen supply manifold, the hydrogen discharge pipe being configured to discharge hydrogen gas obtained by vaporizing the fuel,
in which the hydrogen discharge pipe is configured to discharge the hydrogen gas through a side surface of the dump body.

### REFERENCE SIGNS LIST

2 Dump truck
10 Vehicle body frame
11 Pivot portion
12 Dump body
15 Cab
16 Protector
25 Hydrogen tank
35 Decompression valve
36 Drive source
55 Hydrogen supply pipe
55A First supply portion
55B Second supply portion
55C Third supply portion
56 Hydrogen supply manifold
58 Hydrogen discharge pipe

1. A dump truck comprising:
a vehicle body frame on which a drive source using hydrogen as fuel is mounted, and
a dump body that is pivotably joined to the vehicle body frame at a pivot portion, a load is to be mounted on the dump body,
the dump truck further comprising:
a hydrogen tank configured to store the hydrogen,
wherein the hydrogen tank is provided for the dump body.

2. The dump truck according to claim 1, wherein the dump body includes a protector configured to protect a cab from above, and
the hydrogen tank is provided below the protector.

3. The dump truck according to claim 1, further comprising:
a hydrogen supply pipe configured to supply the hydrogen from the hydrogen tank to the drive source,
wherein the hydrogen supply pipe includes
a first supply portion provided on a lower surface of the dump body,
a second supply portion provided for the vehicle body frame, and
a bendable third supply portion joining the first supply portion and the second supply portion in a vicinity of the pivot portion.

4. The dump truck according to claim 3, further comprising
a decompression valve provided between the second supply portion and the drive source to decompress the fuel,
wherein the first supply portion and the second supply portion are formed of metal pipes, and
the third supply portion is formed of a hose.

5. The dump truck according to claim 3, wherein
the first supply portion including a plurality of first supply portions provided for the dump body,
the dump truck further comprising:
a hydrogen supply manifold provided for the dump body and joining the plurality of first supply portions into the third supply portion.

6. The dump truck according to claim 5, further comprising:
a hydrogen discharge pipe branching off from the hydrogen supply manifold, the hydrogen discharge pipe being configured to discharge hydrogen gas obtained by vaporizing the fuel,
wherein the hydrogen discharge pipe is configured to discharge the hydrogen gas through a side surface of the dump body.

7. The dump truck according to claim 2, further comprising:
a hydrogen supply pipe configured to supply the hydrogen from the hydrogen tank to the drive source,
wherein the hydrogen supply pipe includes
a first supply portion provided on a lower surface of the dump body,
a second supply portion provided for the vehicle body frame, and
a bendable third supply portion joining the first supply portion and the second supply portion in a vicinity of the pivot portion.

8. The dump truck according to claim 7, further comprising
a decompression valve provided between the second supply portion and the drive source to decompress the fuel,
wherein the first supply portion and the second supply portion are formed of metal pipes, and
the third supply portion is formed of a hose.

9. The dump truck according to claim 7, wherein
the first supply portion including a plurality of first supply portions provided for the dump body,
the dump truck further comprising:
a hydrogen supply manifold provided for the dump body and joining the plurality of first supply portions into the third supply portion.

10. The dump truck according to claim 9, further comprising:
a hydrogen discharge pipe branching off from the hydrogen supply manifold, the hydrogen discharge pipe being configured to discharge hydrogen gas obtained by vaporizing the fuel,
wherein the hydrogen discharge pipe is configured to discharge the hydrogen gas through a side surface of the dump body.
